(19) United States
(12) Patent Application Publication
(10) Pub. No.: US 2022/0039424 A1
(43) Pub. Date: Feb. 10, 2022

(54) STICKER KIT FOR MAKING CUSTOMIZED PARTY WARE AND METHODS OF MAKING AND USING THE SAME

(71) Applicant: CONTINENTAL AMERICAN CORPORATION D/B/A PIONEER BALLOON COMPANY, WICHITA, KS (US)

(72) Inventors: RANDY DWAYNE SMITH, LEE'S SUMMIT, MO (US); JOEL THOMAS SCOTT, CHANHASSEN, MN (US)

(21) Appl. No.: 16/986,726

(22) Filed: Aug. 6, 2020

(51) Int. Cl. A23G 3/34; B44C 1/10

(52) U.S. Cl. CPC A23G 3/343; B44C 1/105

(57) ABSTRACT

A sticker kit configured for use in custom decorating party ware items, including tableware items, such as plates, on which food can be served. Related embodiments include a method for producing such a sticker kit and a method for producing customized party ware using such a sticker kit. In one embodiment, the sticker kit includes at least one food grade safe decorative sticker that is formatted or configured (in size and shape) to be secured over the surface of a corresponding plate, bowl, platter or other tableware item for contact with food being served thereon. A do-it-yourself (“DIY”) user can apply the stickers to stock party ware items of any color or style selected by the DIY user to create custom decorated party ware.

### CROSS-REFERENCE TO RELATED APPLICATIONS

Not Applicable.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

### 1. Field of the Invention

The present invention is directed to the field of party ware, and in particular, to a sticker kit for making customized party ware, including tableware on which food may be served.

### 2. Description of Related Art

“Party ware” broadly encompasses a variety of products used for parties and other gatherings including stationery items (e.g. invitations, gift bags, name tags, thank you notes, etc.), tableware (e.g. plates, cups, platters, etc.) and decorations (e.g. banners, balloons, party hats, table tents, table cloths, etc.). Party ware collections, particularly those used for children's parties, are typically decorated in a common theme (e.g. birthday, princess, monster, cars, cartoon characters, etc.) and include disposable tableware. The specific color combinations and themes of party ware collections available for purchase are generally limited to a select number of offerings that have been manufactured for the season/year.

### SUMMARY OF THE INVENTION

The present invention is directed to a sticker kit configured for use in custom decorating party ware items, including tableware items on which food can be served. Related embodiments include a method for producing such a sticker kit and a method for producing custom decorated party ware using such a sticker kit.

In one embodiment, the sticker kit includes at least one food grade safe decorative sticker that is formatted or configured (in size and shape) to be secured over the surface of a corresponding plate, bowl, platter or other tableware item for contact with food being served thereon. The decorative sticker may include one or more decorative elements selected from the group consisting of color, artwork, designs, graphics, photographic images, wording, numbers and combinations of those elements. A do-it-yourself (“DIY”) user can apply the decorative stickers to stock party ware items of any color or style selected by the DIY user to create custom decorated party ware. In one embodiment, the food grade safe decorative sticker is printed with food grade safe inks or dyes. In another embodiment, the food grade safe decorative sticker is coated with a food grade safe surface coating.

In one embodiment, the sticker kit includes at least one decorative sticker configured to be secured over a portion of the top surface of a plate in order to cover a portion of the upper surface of the plate for contact with food being served thereon. For purposes of this application, the terms “configured” and “configuration” should be understood to mean the combined shape and size of the sticker. Preferably, the decorative sticker is configured to cover at least about 50% of the top surface of the plate, more preferably at least about 70% of the top surface of the plate. In one embodiment, the sticker kit includes a decorative sticker configured to cover an area of at least 5 inches squared, preferably to cover an area ranging from about 5 to about 9 inches squared. In one embodiment, the sticker kit includes a round sticker having a diameter ranging from about 5 inches to 8.5 inches. In one embodiment, the sticker kit includes at least two stickers of different size and/or shape, each configured to be secured over a portion of the top surface of a plate in order to cover the majority of the upper surface of the plate. In one embodiment, the sticker kit includes two stickers of different size and/or shape, each sized to cover an area of at least 5 inches squared, preferably to cover an area ranging from about 5 to about 9 inches squared. In one embodiment, the sticker kit includes two round stickers, each having a diameter ranging from about 5 inches to about 8.5 inches.

In one embodiment, the sticker kit includes a set of decorative stickers that are formatted or configured in size and shape to be applied to a corresponding set of party ware items. For example, the set of stickers may include a large round sticker configured to be secured to a dinner size plate, a small round sticker configured to be secured to a cake or appetizer size plate, a large rectangular sticker configured to be secured to the front of a stationery invitation or thank you card, and a small rectangular or round sticker configured to be secured to a sidewall of a drinking cup.

In one embodiment, each set of decorative stickers within the kit may include one or more decorative elements unique to that set of stickers, such as the individual name of a party attendee, to make a personalized cup and/or other party ware items for each attendee. Alternatively, a blank space may be provided on one or more stickers within the set for a user or guest to write his or her name or add other custom indicia. In addition, the decorative elements used on the decorative stickers may have a common decorative theme (using the same or similar decorative elements in various presentations that fit the specific format or configuration of each sticker) for each set and/or for all of the sets within the kit.

In one embodiment, each set of decorative stickers is provided on a sticker sheet. The sticker sheet includes a sticker layer releaseably secured to a release or backing layer. The sticker layer has a top print surface adapted for printing decorative elements thereon and a bottom adhesive surface with a pressure sensitive adhesive thereon. The release or backing layer has a non-stick surface in contact with and covering the bottom adhesive surface of the sticker layer to protect the adhesive until the sticker is removed from the release or backing layer for use. Lines of weakness such as score lines, perforations or solid cut lines may be included in the sticker layer to define the outer perimeter of each sticker and assist in removing each sticker from the remainder of the sticker sheet. In this manner, the decorative stickers on the sticker sheet may be individually removed from the sticker sheet and applied to a corresponding party ware item.

In one embodiment, the sticker kit includes a plurality of sticker sheets wherein each sticker sheet includes at least one decorative sticker configured to be secured over a portion of the top surface of a tableware item, preferably a plate, in order to cover a portion of the upper surface of the tableware for contact with food being served thereon. Preferably, the decorative sticker is configured to cover at least about 50% of the top surface of a plate, more preferably at least about 70% of the top surface of a plate. In one embodiment, each sticker sheet includes at least one decorative sticker configured to cover an area of at least 5 inches squared, preferably to cover an area ranging from about 5 to about 9 inches squared. In one embodiment, each sticker sheet includes a round sticker having a diameter ranging from about 5 inches to about 8.5 inches. In one embodiment, each sticker sheet includes at least two stickers of different size and/or shape, each configured to be secured over a portion of the top surface of a plate in order to cover the majority of the upper surface of the plate. In one embodiment, each sticker sheet includes two stickers of different size and/or shape, each sized to cover an area of at least 5 inches squared, preferably to cover an area ranging from about 5 to about 9 inches squared. In one embodiment, each sticker sheet includes two round stickers, each having a diameter ranging from about 5 inches to about 8.5 inches.

In one embodiment, each sticker sheet includes a set of decorative stickers that are formatted or configured in size and shape to be applied to a corresponding set of party ware items. The configuration of the set of decorative stickers is the same for each sticker sheet, and the decorative elements applied to the decorative stickers is the same for each sticker sheet, except that optionally each sticker sheet within the kit may include one or more unique decorative elements (such as the name of a guest) that is different from another sticker sheet in the kit. In one embodiment, each set of decorative stickers on each sticker sheet within the kit includes at least three decorative stickers of different size and shape. In one embodiment, each set of stickers on each sticker sheet within the kit includes at least four decorative stickers of different size and shape. In one embodiment, each set of stickers on each sticker sheet within the kit includes at least two food grade safe decorative stickers of a different size and shape configured to cover a portion of the top surface of a plate, preferably configured to cover an area of at least 5 inches squared, preferably to cover an area ranging from about 5 to about 9 inches squared. In one embodiment, each set of decorative stickers on each sticker sheet within the kit includes two round stickers, each having a different diameter ranging from about 5 inches to about 8.5 inches.

A related embodiment is directed to a method for producing a sticker kit for use in making custom decorated party ware. The method includes applying one or more decorative elements to at least one sticker sheet to form at least one food grade safe decorative sticker. The sticker sheet may include a sticker layer having an upper surface adapted for printing the decorative elements thereon and a bottom surface with a pressure sensitive adhesive adhered to a backing layer. Lines of weakness extending through the sticker layer such as score lines, perforations or solid cut lines may be formed in the sticker sheet to define stickers that correspond to pre-defined sticker configurations. In one embodiment, the sticker sheet is made by printing the decorative elements on the stickers in the print side of the sticker layer. In one embodiment, the sticker sheet is printed with food grade safe inks or dyes. In another embodiment, the print side of the sticker layer may be coated or laminated with a food grade safe coating after it is printed with the decorative elements.

In one embodiment, the decorative elements are selected by the user and the sticker sheets are “made to order” by printing the selected decorative elements on the sticker sheets and supplying the printed sticker sheets together as a kit to the user. In this embodiment, the user may also select one or more unique decorative elements to include on the individual sticker sheets within the set. For example, the user may select the name of a guest “JOHN” to be printed on one or more stickers within one sticker sheet that is different from the name “BECKY” printed on the corresponding stickers of another sticker sheet within the kit. In this manner, the individual names of the guests may be included on the custom decorated party ware items.

A related embodiment is directed to a method for making custom decorated party ware items. In this embodiment, the user removes the decorative stickers from the sticker sheets provided in the sticker kit and applies the decorative stickers to corresponding party ware items. The user can apply the decorative stickers to stock party ware items of various colors and designs selected by the user to make the items more unique and customized to fit the user's style preferences and needs. The invention is also directed to custom decorated party ware item made in accordance with this method.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a sticker kit in accordance with an embodiment of the present invention;

FIG. 2 is a perspective view of a sticker sheet from the sticker kit of FIG. 1 showing the edges of some of the stickers lifted or removed from the remainder of the sticker sheet;

FIG. 3 is a top plan view of the sticker sheet of FIG. 2 with an example of the types of decorative elements that may be included on the stickers;

FIG. 4 is a perspective view of the sticker sheet of FIG. 2 with two of the stickers removed and placed on corresponding party ware items;

FIG. 5 is a perspective view of party ware items with corresponding stickers from the sticker sheet of FIG. 2 attached;

FIG. 6 is a top plan view of a blank sticker sheet in accordance with an embodiment of the present invention;

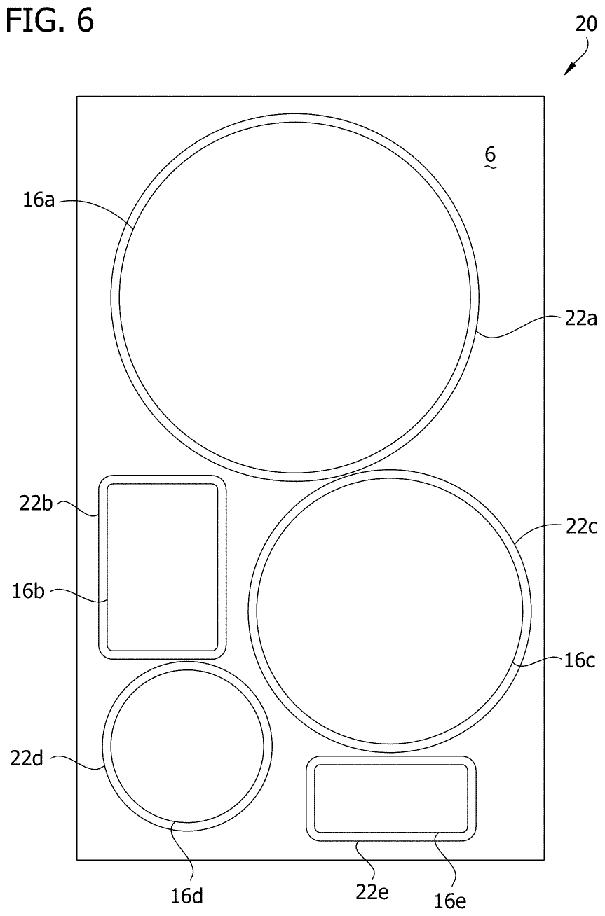

FIG. 7 is a flow diagram depicting the steps for making and using a sticker kit in accordance with an embodiment of the present invention; and

FIG. 8 is a schematic diagram depicting the steps for making and using a sticker kit in accordance with an embodiment of the present invention.

### DETAILED DESCRIPTION OF EXEMPLARY EMBODIMENT

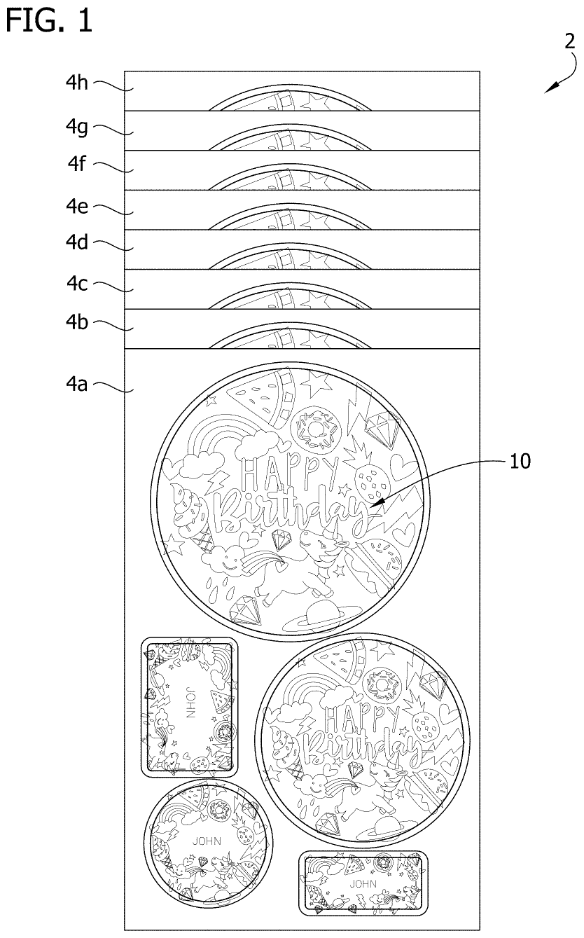

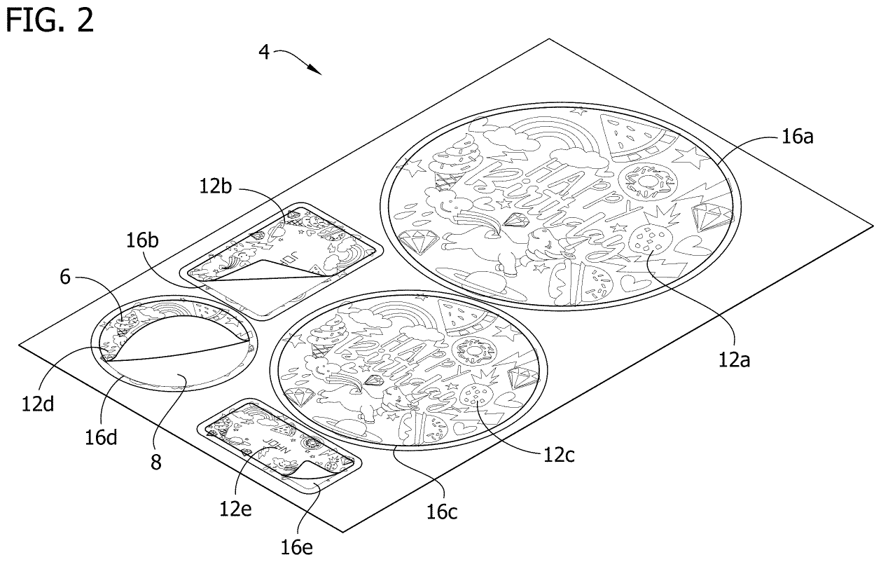

A sticker kit in accordance with an exemplary embodiment of the present invention is designated by the numeral 2 in FIG. 1. As shown in FIG. 1, sticker kit 2 includes a plurality of sticker sheets 4. The number of sticker sheets 4 included within kit 2 may vary, but in the embodiment disclosed, may correspond to the number of anticipated guests for the gathering or event at which the custom decorated party ware will be used. Looking to FIG. 2, each sheet 4 includes a sticker layer 6 with a release or backing layer 8 to which the sticker layer is releasably adhered. The top side of sticker layer 6 provides a surface on which decorative elements 10 may be printed or otherwise applied using conventional methods and/or technologies known in the art. For example, the top side of sticker layer 6 may be formed of paper, plastic or foil that can be printed using conventional color laser printers or printing presses. The underside of the sticker layer 6 includes a pressure sensitive adhesive as is known in the art for use in adhering the sticker layer to another surface. Release or backing layer 8 presents a non-stick surface on which the backside of sticker layer 6 is releaseably adhered. The release or backing layer 8 serves to maintain and protect the pressure sensitive adhesive on sticker layer 6 until it is removed from the sticker sheet for use.

In one embodiment, sticker sheet 4 is made from conventional laser label paper stock, preferably label paper stock ranging from 30 to 60 pound weight paper stock, suitable for printing with laser color printers. As discussed hereinafter, the laser label paper is then die cut to form lines of weakness 16 that define the outer perimeters of stickers 12.

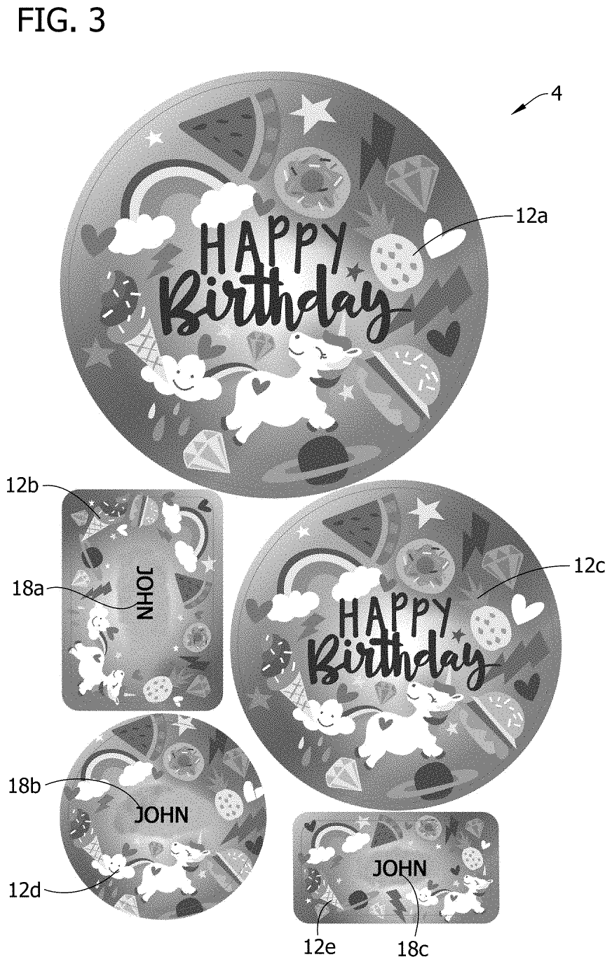

Looking to FIG. 3, decorated stickers 12a, 12b, 12c, 12d, 12e are printed with decorative elements having a common theme (in this case a Happy Birthday theme with unicorns, rainbows, pineapples, and other designs). Decorated stickers 12 include lines of weakness 16a, 16b, 16c, 16d, 16e that define the perimeter of each sticker 12a, 12b, 12c, 12d, 12e respectively and enable each sticker to be independently removed from the remainder of sticker sheet 4 (FIG. 2). Lines of weakness 16 may be formed using conventional techniques known in the art to enable each sticker 12 to be removed from the remainder of sticker sheet 4 such as by die cutting solid or broken lines in sticker layer 6.

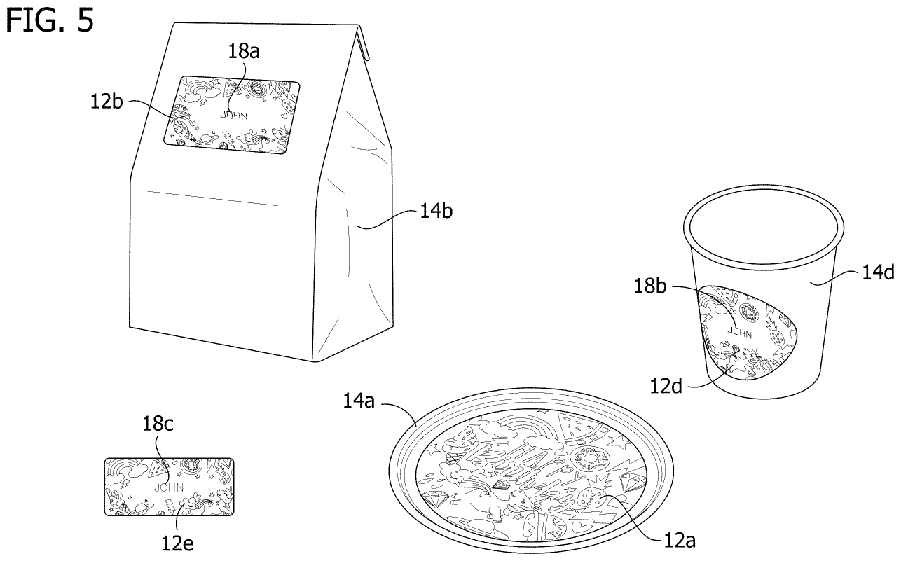

In the exemplary embodiment, sticker 12a is configured to be secured over a portion of the top surface of a dinner-size plate 14a (FIG. 5) in order to cover the majority of the upper surface of the dinner plate for contact with food being served thereon. For purposes of this application, the terms “configured” and “configuration” should be understood to mean the combined shape and size of the sticker. Preferably, sticker 12a is configured to cover at least about 50%, more preferably at least about 70%, of the top surface of the plate. In the embodiment shown, sticker 12a is a round sticker having a diameter of about 6.5 inches configured for decorating a standard-size round paper dinner plate having a diameter of about 9 inches.

Sticker 12b is configured to be secured over a portion of the front of a stationery note card for use as an invitation or thank you note, or alternatively for attaching to the surface of another party ware item such as a gift bag 14b (FIG. 5), or alternatively can be used as a nametag for a party guest. The configuration of sticker 12b as shown is rectangular with round corners and about 3.25 inches by about 2.5 inches in size.

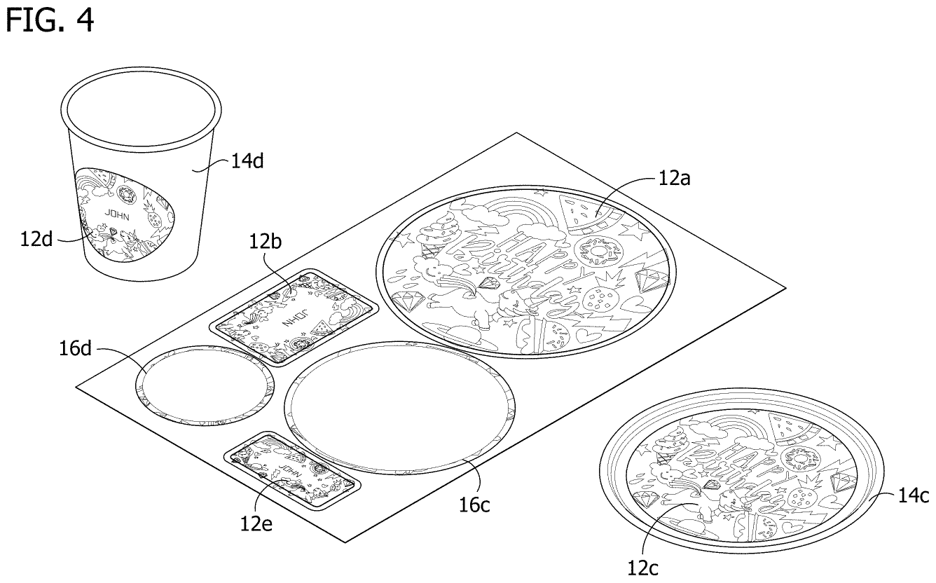

Sticker 12c is configured to be secured to a portion of the top surface of a smaller dessert or appetizer plate 14c (FIG. 4) to cover the majority of the upper surface of the plate, preferably to cover at least 50% of the upper surface of the plate and more preferably to cover at least 70% of the upper surface of the plate. In the embodiment shown, sticker 12c is round and about 5 inches in diameter. Sticker 12c is configured to decorate a standard-size round paper desert plate having a diameter of about 7 inches.

Sticker 12d is configured to be secured to the sidewall of a drinking cup 14d (FIG. 4). In the embodiment shown, 12d is round and about 3 inches in diameter. Lastly, sticker 12e is configured as a small tag to be secured to a stationery note card or gift bag. Alternatively, sticker 12e could be secured to a different party ware item or used as a personal nametag for a party guest. In the embodiment shown, sticker 12e is rectangular in shape with round corners and about 2 inches by about 1.5 inches in size.

As shown in FIG. 3, stickers 12b, 12d, and 12e may include unique text or wording 18a, 18b, 18c. It is anticipated that this unique wording may be the same on each sticker sheet 4 or could be different for each sticker sheet 4 within the kit 2. For example, wording 18 on a first sheet 4 may be the name of a party guest (e.g. “JOHN”) and wording 18 on a second sheet 4 within the kit may be a different name (e.g. “BECKY”).

Stickers 12 are food grade safe so that they may be applied to a tableware item such as the dinner plate 14a or dessert plate 14c in contact with food being served thereon. The stickers may be made food grade safe using various methods as is known in the art. For example, the inks or dyes used to make the decorative elements printed on the stickers may be food grade safe. Any food grade safe inks or dyes suitable for applying the decorative elements on the sticker sheet may be used for this purpose. For example, off-the-shelf food grade safe inks commercially available from Kao Collins, Inc. may be used in printing the decorative elements on the sticker sheets via Ricoh branded color printers. Alternatively, a food grade safe coating may be applied over the inks and dyes used to make the decorative elements. Food grade safe coatings are well known in the art. In one embodiment, the coating is a water-based coating applied by a laminator over decorative elements that have been printed on the sticker sheet with conventional laser printer inks. An acceptable coating for purposes of the invention is an off-the-shelf coating for Ricoh brand laminators commercially available as 2044DE Heat Resistant Food Grade Waterbased Coating from Coatings & Adhesive Corporation.

Stickers 12 and the corresponding party ware items 14 custom decorated with stickers 12 may be biodegradable by using biodegradable sticker blanks, inks and/or dyes, coatings and party ware items. Similarly, stickers 12 and the corresponding party ware items 14 custom decorated with stickers 12 may be recyclable by using sticker blanks, inks and/or dyes, coatings and party ware items that are suitable for recycling.

Each sticker sheet 4 may include a set of stickers (a “sticker set”) comprised of a plurality of stickers, each having a configuration corresponding to a set of party ware items (a “party ware” set) to be decorated. As shown in FIGS. 3-5, the sticker set includes stickers 12a, 12b, 12c, and 12d configured to correspond with a party ware set consisting of a large plate 14a, a stationery notecard or gift bag 14b, a small plate 14c, and a cup 14d. An additional sticker 12e may be used as a nametag or may be applied to other partyware items such as a gift bag, notecard or table place marker. As previously discussed, one or more stickers 12 may include a unique decorative element, such as the name of a guest or anticipated attendee at the event, to enable cups, gift bags, name tags, gift bags, plates or other party ware items to be personalized for use by those specific guests. Alternatively, one or more stickers 12 may include a blank space that can be filled in by the user or guest. All of the sticker sheets 4 within a kit 2 may include the same sticker set with the same decorative elements, except that the unique decorative elements (such as the guest name) can be different for each sheet 4.

Kits 8 may additionally include party ware items 14 on which the stickers 12 will be applied. These party ware items may include a variety of different party ware items desired to be decorated. For example, these party ware items may include one or more plates, cups, bowls, serving dishes and other types of tableware on which food is served, as well as table place markers, gift bags, stationery note cards for invitations or thank you notes, and party hats. It is also anticipated that one of the stickers within each set may be used as a name tag.

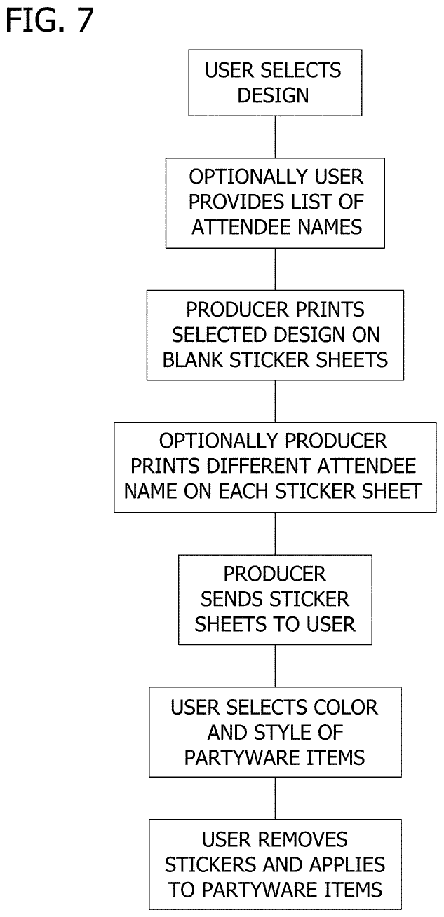

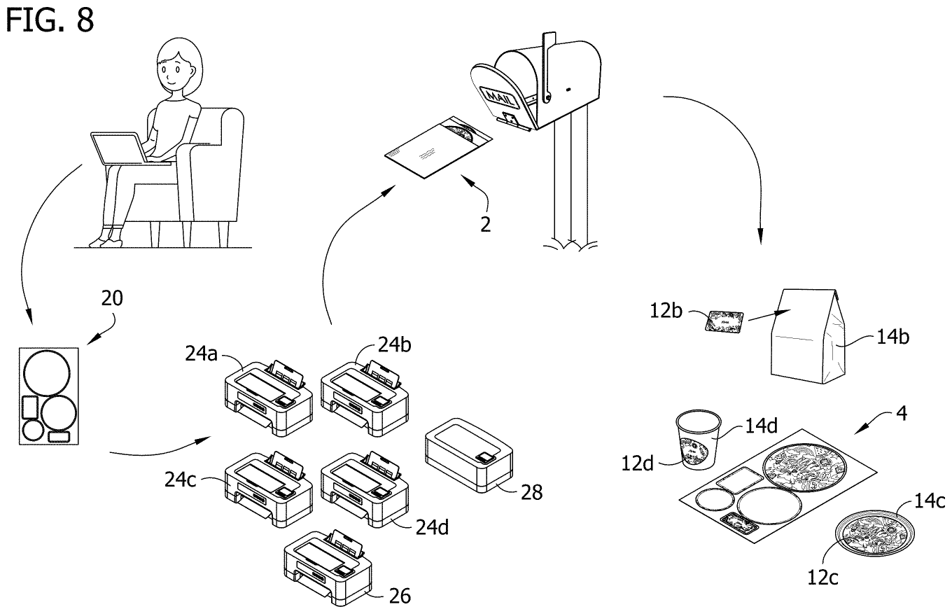

In one embodiment, the sticker kits are customized and/or “made to order” for a DIY user. With reference to FIGS. 7 and 8, in this embodiment the DIY user is given the opportunity to select the particular decorative elements that he or she desires to be included on the stickers 12 within the sticker kit 2. In one embodiment, the user may select the decorative elements from an on-line or print catalog showing or describing the various decorative elements available for use. In addition, it is anticipated that a user may optionally supply the decorative elements for use on the stickers 12 such as by uploading a design or photographic image to a website through which the sticker kits may be ordered or otherwise supplying the design or photographic image to the sticker kit manufacturer.

In an optional embodiment, the user may provide the names of anticipated guests or attendees to be included on the individual sticker sheets 4 within kit 2. In this embodiment, it is anticipated that each sticker sheet 4 would be printed for each guest such that each sticker sheet would have the name of one of the anticipated guests or attendees. Alternatively, the decorative elements may include a blank space on one or more stickers 12 on each sticker sheet 4 within kit 2, wherein the name of a guest can be written by the user when decorating the party ware or by the guests themselves when they arrive at the party or other event. The user would also order the number of sticker sheets 4 to be included within the kit or kits sufficient to make the decorated party ware items needed for the event.

In addition, the user may be given the option to also order the party ware items (e.g. plates, cups, invitations, etc.) on which the stickers will be secured. Alternatively, the DIY user may otherwise purchase the party ware items through local or on-line sources. Upon placing his or her order, the customized sticker kits may be produced as described hereinafter and shipped or otherwise delivered to the user. The user can then apply the stickers 12 to the corresponding party ware items 14 that the user selected to make the custom decorated party ware.

Looking to FIG. 5, to produce sticker kits 8 as shown, a blank sticker sheet 20 is printed with the decorative elements selected by the user. Blank sticker sheet 20 includes the sticker layer 6 secured over the release or backing layer 8 as previously discussed (See FIGS. 2 and 4). Lines of weakness 16a, 16b, 16c, 16d, 16e pre-cut or formed in the sticker layer define the perimeter of the decorative stickers 12a, 12b, 12c, 12d, 12e (FIG. 3) to be printed. In the embodiment shown in FIG. 8, each blank sticker sheet 20 is passed through one or more color printers, such as conventional color laser printers, that have been programmed to print the selected decorative elements within sticker areas 22a, 22b, 22c, 22d, 22e (FIG. 5) corresponding to stickers 12a, 12b, 12c, 12d, 12e respectively. It is noted that sticker areas 22 in which the decorative elements are printed are somewhat larger than stickers 12 to ensure a complete decoration up to the edge of each sticker is provided.

As discussed earlier, individual sticker sheets 4 within a kit may differ in that certain unique decorative elements, such as the name of a guest, on one sheet 4 may be different from the unique decorative element on another sheet 4. The various names or other unique decorative elements to be included on the individual sheets would also be programmed into the printers as is known in the art such that each sheet will be printed with the selected unique element.

Sticker sheets 4 may be printed using food grade safe inks or dyes as is known in the art and may be printed using various printing techniques including using multiple printers in series with different colors. In the embodiment shown in FIG. 8, the sticker sheets are printed using five color processing techniques wherein the blank sticker sheet is run through four color printers 24a, 24b, 24c, 24d in series by which various colors for the decorative elements are applied in the sticker areas and then a coating is applied with a fifth coating printer 26 to fix the color. In addition, the sticker sheets 4 may be laminated with a food grade safe coating via a laminator 28.

The printed sticker sheets 4 may then be collected into groups to make one or more kits per order and shipped or otherwise delivered to the user. Upon receipt, the user may remove the decorated stickers 12 from the sticker sheets 4 and apply the decorated stickers to corresponding party ware items 14. Given that the user selects the various party ware items on which the stickers will be applied (including the color and style of those items), selects the decorative theme of the stickers (i.e. the decorative elements applied to the stickers), and optionally provides individual names or other unique decorative elements to differentiate the stickers on each sheet, the user is able to make custom decorated party ware with unique combinations of different colors, designs, and styles and to further personalize the individual party ware items for guests.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense. For example, while specific configurations of stickers are shown in the FIGURES, it is understood that a wide variety of different configurations of stickers may be used that fall within the scope of the invention. For instance, it is anticipated that stickers configured to be secured to a plate or cup to decorate the same could be shaped other than round (e.g. squared, rectangular, triangular, star-shaped, etc.) without departing from the invention. Similarly, the invention is not limited to the specific party ware items that are described and shown in the specification.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A sticker kit for making custom decorated party ware, said sticker kit comprising:
at least one sticker sheet comprising at least one sticker having one or more decorative elements thereon, wherein at least one of said at least one stickers is a food grade safe sticker configured to be secured over the surface of a tableware item for contact with food being served thereon.

2. The sticker kit of claim 1, wherein said food grade safe sticker comprises one or more decorative elements printed thereon with food grade safe inks or dyes.

3. The sticker kit of claim 1, wherein said food grade safe sticker comprises a food grade safe coating over said one or more decorative elements.

4. The sticker kit of claim 1, wherein said at least one sticker is removable from said sticker sheet and is configured to be secured to a party ware item to decorate the party ware item.

5. The sticker kit of claim 1, wherein said at least one sticker is removable from said sticker sheet and corresponds in shape to a portion of a party ware item on which the sticker may be secured to decorate the party ware item.

6. The sticker kit of claim 1, wherein said food grade safe sticker is configured to be secured to a portion of a top surface of a plate.

7. The sticker kit of claim 6, wherein said food grade safe sticker is configured to cover at least 50% of the top surface of the plate.

8. The sticker kit of claim 7, wherein said food grade safe sticker is round and configured to cover at least 70% of the top surface of the plate.

9. The sticker kit of claim 1, wherein said food grade safe sticker is configured to cover an area of at least 5 inches squared.

10. The sticker kit of claim 9, wherein said at least one sticker sheet comprises two food grade safe stickers of different size, each configured to be secured to a top surface of a corresponding plate.

11. The sticker kit of claim 1, wherein said at least one sticker sheet comprises a plurality of stickers, each of which has a configuration corresponding to a different party ware item on which the sticker may be attached to decorate the party ware item.

12. The sticker kit of claim 11, wherein said at least one sticker sheet comprises at least one food grade sticker configured to be attached to a plate to cover a portion of the top surface of the plate, a sticker configured to be attached to a stationery card to cover a portion of the top surface of the card, and a sticker configured to be attached to an outer sidewall of a cup.

13. The sticker kit of claim 1, wherein the sticker kit includes a plurality of said sticker sheets and a unique decorative element is provided on at least one sticker on one sticker sheet that is different from a corresponding unique decorative element on another sticker sheet.

14. The sticker kit of claim 13, wherein the unique decorative element comprises wording.

15. The sticker kit of claim 11, wherein said at least one sticker sheet comprises a sticker layer on which the one or more decorative elements are printed, removably secured to a backing layer via a pressure sensitive adhesive, and wherein lines of weakness extend in the sticker layer to define the perimeter of each of the stickers respectively and to enable each sticker to be removed from the remainder of the sticker sheet by a user.

16. A method for producing a customized sticker kit for making custom decorated party ware, said method comprising:
a. prompting a user to select one or more decorative elements for the custom decorated party ware;
b. providing at least one sticker sheet comprising a sticker layer having an upper surface adapted for printing thereon and a bottom surface with a pressure sensitive adhesive thereon, wherein pre-cut lines of weakness in the sticker layer define at least one sticker configured to correspond with a party ware item to be decorated;
c. printing the decorative elements selected by the user on said at least one sticker to form a decorated sticker, wherein at least one of said decorated stickers is a food grade safe sticker configured to be secured on the surface of a tableware item for contact with food being served thereon.

17. The method of claim 16, wherein said food grade safe decorated sticker comprises decorative elements printed with food grade safe inks or dyes.

18. The method of claim 16, wherein said food grade safe decorated sticker comprises a food grade coating over said decorative elements.

19. The method of claim 16, wherein said food grade safe decorated sticker is configured to be secured to a top surface of a plate.

20. The method of claim 19, wherein said food grade safe sticker is configured to cover at least 50% of the top surface of the plate.

21. The method of claim 20, wherein said food grade safe decorated sticker is round and configured to cover at least 70% of the top surface of the plate.

22. The method of claim 16, wherein said at least one sticker sheet comprises a plurality of stickers, each of which has a configuration corresponding to a different party ware item on which the sticker may be attached to decorate the party ware item.

23. The method of claim 22, wherein said sticker kit comprises a plurality of said sticker sheets.

24. The method of claim 17, wherein at least one decorated sticker on one of said plurality of sticker sheets comprises a unique decorative element different from at least one decorated sticker on another one of said plurality of sticker sheets.

25. The method of claim 24, wherein said unique decorative element comprises wording.

26. A method of making custom decorated party ware items, said method comprising:
a. selecting one or more decorative elements;
b. receiving at least one sticker sheet comprising a sticker layer having an upper surface adapted for printing thereon and a bottom surface with a pressure sensitive adhesive removably secured to a backing layer, wherein pre-cut lines of weakness define a plurality of stickers on the sticker sheet, each of said plurality of stickers configured to correspond with a party ware item to be decorated;
c. printing the decorative elements selected by the user on said plurality of stickers to form decorative stickers, wherein at least one of said decorative stickers is food grade safe such that it may be secured on the surface of a tableware item for contact with food being served thereon;
d. removing each decorative sticker from the sticker sheet and applying the decorative sticker to a corresponding party ware item.

27. The method of claim 26 wherein said party ware items are selected from the group consisting of a dinner plate, a desert or appetizer plate, a cup, a stationery note card, a gift bag and combinations thereof.
